(19) United States
(12) Patent Application Publication
(10) Pub. No.: US 2008/0281921 A1
(43) Pub. Date: Nov. 13, 2008

(54) SYSTEMS AND METHODS FOR INTER-DOMAIN MESSAGING

(75) Inventor: DANIEL C. HUNT, CARLSBAD, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: YAHOO! INC., SUNNYVALE, CA (US)

(21) Appl. No.: 11/746,025

(22) Filed: May 8, 2007

(51) Int. Cl. G06F 15/16

(52) U.S. Cl. 709/206

(57) ABSTRACT

Methods and systems are disclosed herein for relaying a digital message from a first browser module to a second browser module. A webpage can be received from a first domain server. The webpage can have a link to a URI that references a web service on a second domain server. The webpage can be displayed in a first browser module. The URI can be referenced so as to invoke the web service. A cookie can be received from a web service and detected by a monitoring module. The cookie detected can be provided to the second browser module.

### BACKGROUND

1. Field

The present disclosure relates to digital messaging. In particular, it relates to systems and methods of providing messaging between browser modules.

2. General Background

Browser security restrictions severely restrict the communication that can occur between browser windows that communicate with different web domains. These restrictions are necessary and obvious given the numerous Cross Site Scripting (XSS) attacks that have destroyed data or violated user privacy. These exploits have lead many community sites to deeply limit the type of content that can be introduced to blogs or user pages. These same security barriers also prevent innovation and web application interoperability by preventing trusted sources to reliably communicate on the desktop.

### SUMMARY

In one aspect, there is a method for relaying a digital message from a first browser module to a second browser module. A webpage can be received from a first domain server. The webpage can have a link to a URI that references a web service on a second domain server. The webpage can be displayed in a first browser module. The URI can be referenced so as to invoke the web service. A cookie can be received from a web service and detected by a monitoring module. The cookie detected can be provided to the second browser module. Furthermore, a cookie database can be monitored to determine whether a cookie has been received from the web service.

In another aspect, the URI can be referenced by sending parameters to the web service. The parameters can include at least a portion of the digital message that the first browser module relays to the second browser module.

In another aspect, the cookie includes digital data to be rendered by the second browser module. The first domain server can be a server in a first web domain, and a second domain server can be a server of a second web domain.

In one aspect, there is a method relaying a digital message from a first browser module to a second browser module. Hypertext can be received at a first browser module. The hypertext can include a URI which references a web service provided by a second domain server. A monitoring module can be received from the second domain server. The monitoring module can be received at a second browser module. The monitoring module can be executed in association with the second browser module. The monitoring module can be configured to monitor a cookie database to detect new cookies.

The hypertext can be rendered in association with a selectable interface on a webpage rendered on the first browser module such when the selectable interface is selected, the URI is invoked. A selection of the selectable interface can be received on the webpage. The web service identified by the URI can be received at the second domain server. A cookie can be received from the second domain server. The cookie can be stored from the second domain such that the monitoring module can detect the cookie on a second window of the browser.

In one aspect, there is a system, comprising a first browser module, a second browser module, and a monitoring module. The first browser module can communicate with first domain server. The first browser module can be configured to receive on or more cookies from a web service of a second domain server and store the one or more cookies in a cookies database. The second browser module can communicate with second domain server. The monitoring module can be associated with the second browser module. The monitoring module can be provided by the second domain server. The monitoring module can be configured to detect a new cookie in the cookie database, and to provide the new cookie to the second browser module.

In one aspect, there is a method of receiving a digital message. A URI can be embedded on hypertext by a first domain server. The URI references a web service of a second domain server.

The hypertext can be provided to a first browser module configured to display the hypertext as a webpage such that when the URI is selected on the webpage. The web service of the second domain server can be invoked to create a cookie that is transmitted to the client computer. The client computer can be configured with a second browser module that can read the cookie.

In another aspect, there is a method of receiving a digital message. A request for a web service can be received. The request can be submitted from a webpage being rendered at a client computer by a first browser module that displays hypertext associated with a first domain server. A monitoring module can be provided to the client computer such that the monitoring module can be executed in association with a second browser module. The web service can be executed in order to provide a cookie to the client computer. A cookie can be dropped to the client computer such that the second browser module can read the cookie.

In one aspect, there is a method of sending a message from a first browser module to a second browser module, comprising making a call to a web service from a first browser module of a client computer by encoding the message in parameters of a call to the web service. The web service can be configured to parse the parameters and send a cookie back to the client computer. Data contained in the cookie is utilized by a second browser module.

In another aspect, there is a method of receiving a message. The method comprises receiving, from a web service, a cookie at a monitoring application. The cookie can be sent from the web service as a result of a call to the web service from a first browser module that encodes the message in parameters of the call to a web service. The data contained in the cookie can be provided to a second browser module.

### DRAWINGS

The features and objects of alternate embodiments of the present disclosure will become more apparent with reference to the following description taken in conjunction with the accompanying drawings of various examples wherein like reference numerals denote like elements and in which:

FIG. 1 depicts a component diagram of a system for providing inter-domain messaging.

FIG. 2 depicts a component diagram of a computing device according to one embodiment.

FIG. 3 depicts an exemplary diagram of process interaction according to one embodiment.

FIG. 4 depicts an exemplary diagram of process interaction for sending an inter-domain message according to one embodiment.

FIG. 5A depicts an exemplary user interface of a first domain window and a second domain window according to one embodiment.

FIG. 5B depicts an exemplary user interface of a first domain window and a second domain window according to another embodiment.

FIG. 6 depicts a flow diagram of a process for providing inter-domain messaging according to one embodiment.

FIG. 7 depicts a flow diagram of a process for providing inter-domain messaging according to another embodiment.

FIG. 8 depicts a flow diagram of a process for providing inter-domain messaging according to yet another embodiment.

FIG. 9 depicts a flow diagram of a process for providing inter-domain messaging according to another embodiment.

### DETAILED DESCRIPTION

The system and method disclosed herein permits inter-domain communication between two browser modules. Thus, inter-domain messaging between two web browser windows that display data from two different web domains can be performed according to the methods and systems disclosed here. Browser modules broadly refer to a computer implemented process that permits a client computer to communicate with one or more web resource via a computer network. Browser modules can be associated with, comprise, or be part of, a domain window. As such, a domain window is a user interface that allows to display one or more web elements being rendered by a browser module.

As such, inter-domain messaging refers to the transmission of a message from a first browser module to a second browser module. The first browser module can display web content from a first web domain via a first domain window. The second browser module can display web content from a second web domain via a second domain window.

Thus a document being rendered by a first browser module can communicate with a document being rendered by a second browser module, even when the browser modules are rendering web content from different web domains.

Via the methods disclosed herein, the communication between browser modules is also be secure. As such, a the message being sent from the first browser module to the second browser module cannot be intercepted, inspected, or changed.

The method disclosed herein utilizes a web service to route the message, and a monitoring module at the client computer to listen when the cookie has arrived. The message can then be routed through the web service and sent to the first browser module, for later access by the second access module.

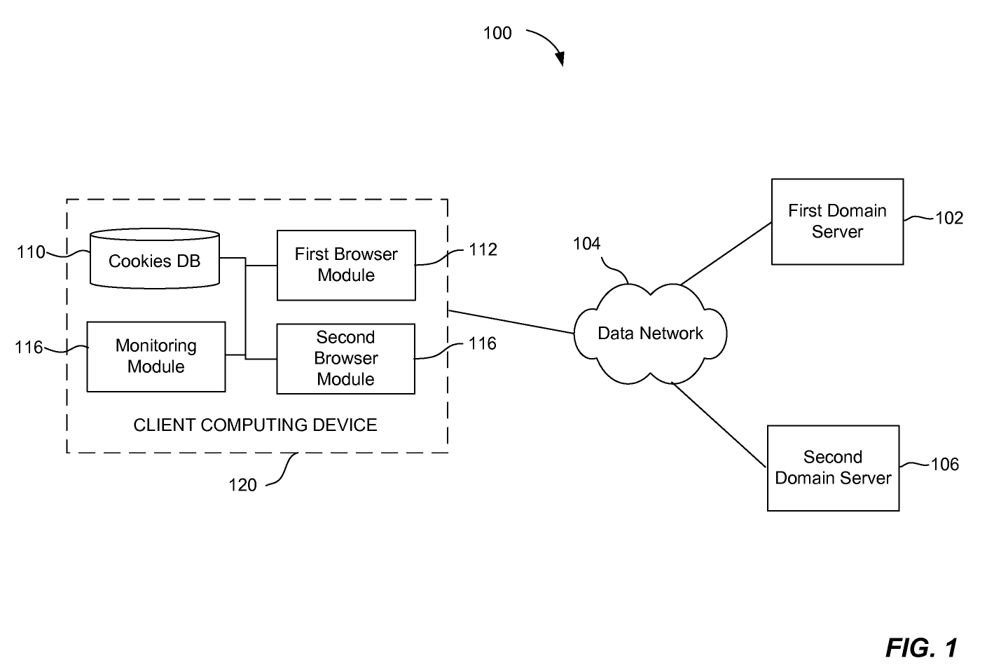

FIG. 1 depicts a component diagram of a system for providing inter-domain messaging. System 100 illustrates a client computing device 120 that communicates with a first domain server 102 and second domain server 106 through a data network 104. The data network 104 can be for example the Internet. In another example, the data network 104 can be an intranet. The client computing device 120 can be configured with a first browser module 112 that can render web pages, web applications, and any other web elements. The first browser module 112 can further be configured to access a cookies database 110 wherein the first browser module 112 can store received cookies. The first browser module 112 can include a user interface display configured to display a window.

The client computing device 120 can be configured with a second browser module 116 that can render web pages, web applications, and any other web elements. In addition, the second browser module 116 can also be configured to access the cookies database 110 in order to retrieve data for rendering a web page or displaying an event.

In one embodiment, the first browser module 112 can also be configured to receive hypertext from one or more domains and render such hypertext in a browser window. For example, the first browser module can display web pages provided by the first domain server 102. In another embodiment, the second browser module 116 can also be configured to receive hypertext from one or more domains and render such hypertext in a browser window. For example, the second browser module 116 can display web pages provided by the second domain server 106. As utilized herein, a browser module can be any computer logic and/or computer implemented process configured to receive and render web elements, as well as to interact with web services, web servers, and web components in general. Thus, for example, a browser module can be a commonly known browser such as Internet Explorer®, FireFox®, or Opera®.

In yet a further embodiment, a monitoring module 114 can also be running in the computer environment of the client computing device 120. The monitoring module 112 can be configured to periodically or regularly query the cookies database 110 to determine whether the cookies database 110 now includes an additional cookie. In one embodiment, the monitoring module 114 can be configured to monitor cookies within a specific scope. For example, the monitoring module 114 can be configured to search for cookies within a specific domain and/or that have a specific name.

If a new cookie is found by the monitoring module 114, the monitoring module can communicate the data associated to the cookie to the second browser module 116.

In one embodiment, the second domain server 106 can include a web service that is invoked by the first browser module 112 and that drops a cookie to the first browser module 112 so that the first browser module 112 can store the new cookie on the cookies database 110. A monitoring module 114 can detect the presence of such new cookie and treat the new cookie as a message that provides data to the second browser module 116.

One skilled in the art will recognize that the cookies database 110 can be combined into one or more data repositories, and be located either locally or remotely. In addition, each of the aforementioned databases can be any type of data repository configured to store data and can be implemented using any methods of storage now known or to become known. Likewise, while various modules have described herein, one skilled in the art will recognize that each of the aforementioned modules can be combined into one or more modules, and be located either locally or remotely. Each of these modules can exist as a component of a computer program or process, or be standalone computer programs or processes recorded in a data repository.

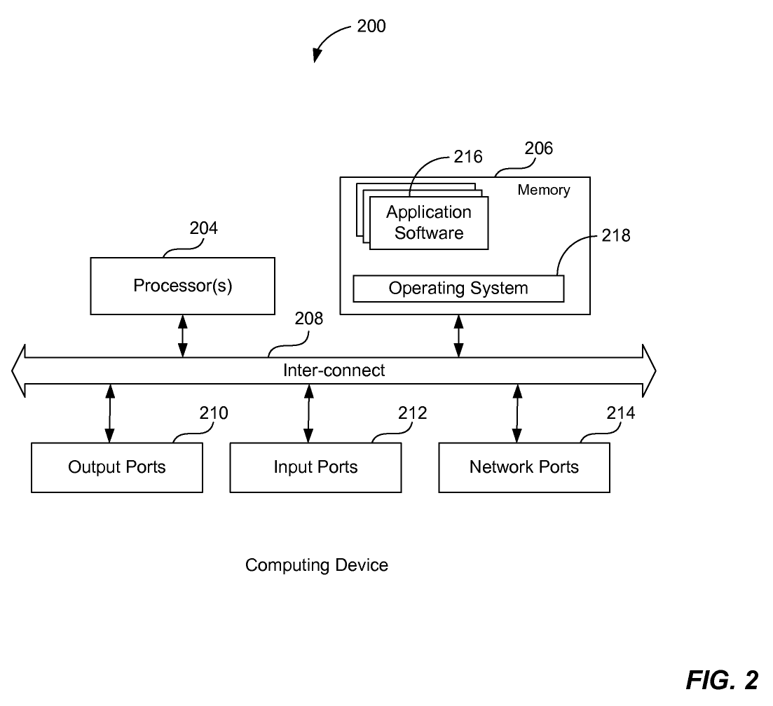

FIG. 2 depicts a component diagram of a computing device according to one embodiment. The computing device 200 can be utilized to implement one or more computing devices, computer processes, or software modules described herein. In one example, the computing device 200 can be utilized to process calculations, execute instructions, receive and transmit digital signals, as required by the jobseeker computing device 102. In another example, the computing device 200 can be utilized to process calculations, execute instructions, receive and transmit digital signals, receive and transmit search queries, job listings, and hypertext, as required by the first browser module 112, the second browser module 116, and the monitoring module 114.

The computing device 200 can be any general or special purpose computer now known or to become known capable of performing the steps and/or performing the functions described herein, either in software, hardware, firmware, or a combination thereof.

The computing device 200 includes an inter-connect 208 (e.g., bus and system core logic), which interconnects a microprocessor(s) 204 and memory 206. The inter-connect 208 interconnects the microprocessor(s) 204 and the memory 206 together. Furthermore, the interconnect 208 interconnects the microprocessor 204 and the memory 206 to peripheral devices such input ports 212 and output ports 210. Input ports 212 and output ports 210 can communicate with I/O devices such as mice, keyboards, modems, network interfaces, printers, scanners, video cameras and other devices. In addition, the output port 210 can further communicate with the display 104.

Furthermore, the interconnect 208 may include one or more buses connected to one another through various bridges, controllers and/or adapters. In one embodiment, input ports 212 and output ports 210 can include a USB (Universal Serial Bus) adapter for controlling USB peripherals, and/or an IEEE-1394 bus adapter for controlling IEEE-1394 peripherals. The inter-connect 208 can also include a network connection 214.

The memory 206 may include ROM (Read Only Memory), and volatile RAM (Random Access Memory) and non-volatile memory, such as hard drive, flash memory, etc. Volatile RAM is typically implemented as dynamic RAM (DRAM), which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory may also be a random access memory.

The memory 206 can be a local device coupled directly to the rest of the components in the data processing system. A non-volatile memory that is remote from the system, such as a network storage device coupled to the data processing system through a network interface such as a modem or Ethernet interface, can also be used. The instructions to control the arrangement of a file structure may be stored in memory 206 or obtained through input ports 212 and output ports 210.

In general, routines executed to implement one or more embodiments may be implemented as part of an operating system 218 or a specific application, component, program, object, module or sequence of instructions referred to as application software 216. The application software 216 typically can comprises one or more instruction sets that can be executed by the microprocessor 204 to perform operations necessary to execute elements involving the various aspects of the methods and systems as described herein. For example, the application software 216 can include video decoding, rendering and manipulation logic.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

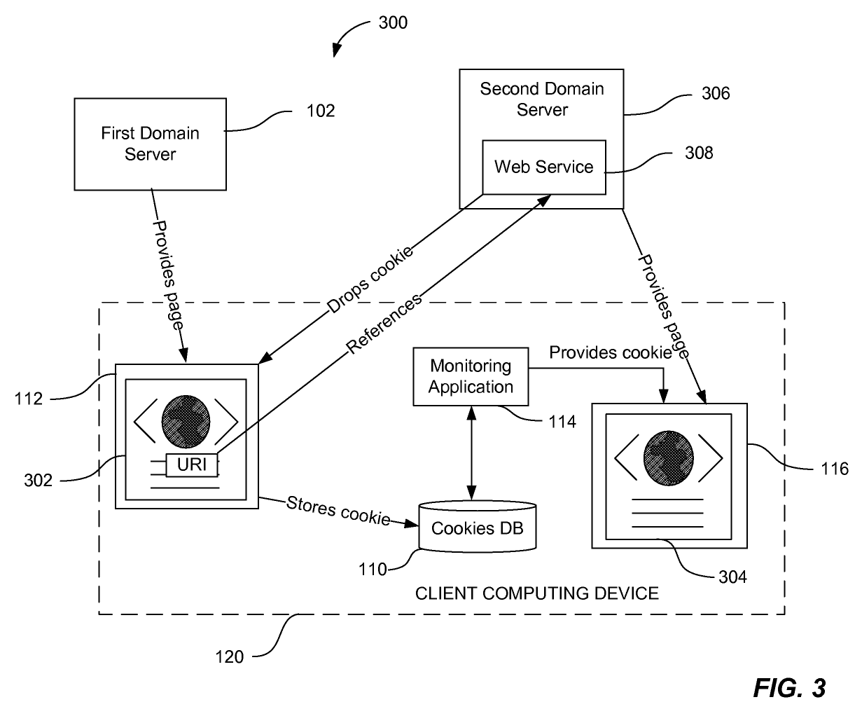

FIG. 3 depicts a diagram of a process interaction according to one embodiment. The first domain server 102 can be configured to provide to the first browser module 112 with hypertext images and other web elements at the request of the first browser module 112. The web elements provided by the first domain server 102 can include a web page that is provided to the web browser and is displayed at a first domain window 302. In one embodiment, the webpage provided by the first domain server 102 can also include a URI 310 to be displayed as a link for any other element in the first domain window 302. In another embodiment, the webpage provided by the first domain server 102 can also include a URI 310 that references a web service 308 and that can be invoked when from the first browser module 112.

The web elements provided by the first domain server 102 can be displayed in the first domain window 302 by interpretation of the hypertext and rendition of such hypertext by the first browser module 112.

The first domain window 302 can display a URI that references the web service 308. As mentioned earlier, the web service can reside at a second domain server 306. Thus, when the URI that references the web service 308, the web service 308 can be invoked. Such selection of the URI and invocation of the web service 308 can be performed by making a call to the web service. A call can include the name of the web service as well as parameters that are passed to the web service 308. In one embodiment, the parameters can include at least a portion of the a message being sent from the first domain window 302 to a second domain window 304. In another embodiment, the parameters can include identifiers of media to be displayed in a second domain window 304. In another embodiment, the parameters can include user data such as browsing history, personal and demographic data, purchasing habits, etc. Based on such parameters, the web server 308 can provide a cookie that includes data to be read and interpreted by the first browser module 112 and displayed at the second domain window 304.

The web service 308 can be configured to validates the query parameters and set or append the data to a cookie and returns the cookie to the first browser module. Once the web service 308 is called, the web service 308 can drop a cookie back to the first browser module 112. As mentioned above, the web service 308 can be invoked by various methods. In one example, the web service 308 is invoked upon the first domain window 302 being loaded. In another example, the web service 308 can be invoke upon a web element being displayed in the first domain window 302 is selected by a user. The first browser module 112 upon receiving a cookie from the web service 308, can store the cookie in a cookie database 110. The cookie database 110 is of course accessible to the first browser module 112 and can provide write permissions to the first browser module 112.

In one embodiment, the second domain server 306 can host both the web service 308 and the webpage 304. In another embodiment, the second domain server 306 hosts the web service 308 and secondary server hosts the webpage 304. In another embodiment, the second domain server 306 hosts the webpage 304 and a secondary server hosts the web service 308. In yet other embodiments, the web service 308 and the webpage 304 can be part of different domains, or sub-domains.

Furthermore, the client computing device 120 can also include a monitoring module 114 that is configured to periodically or regularly monitor new cookies that have been stored at the cookies database 110. The monitoring module 114 can be an application that was previously installed at the client computing device 120 prior to the receipt of the cookie by the first browser module 112. In one embodiment, the monitoring module 114 can be a web application that is downloaded from the second domain server 306. For example, the monitoring module 114 can be a script that is interpreted by the second browser module 112 at runtime. Once the monitoring module 114 detects that a new cookie has been stored at the cookies database 110, the monitoring module 114 can provide such cookie to the first browser module 112 such that the first browser module 112 can render a web page at the second domain window 304. The second domain window 304 can display the web page along with any other data received or appended to the cookie. Thus, for example, the data appended to the cookie can correspond to the data received as a parameter to the call to the web service 308. As such, a first domain window 302 can request or invoke a web service 308 and thus submit a message to the second domain window 304 by requesting the web service 308 to submit a cookie that is ultimately utilized to present data at the second domain window 304.

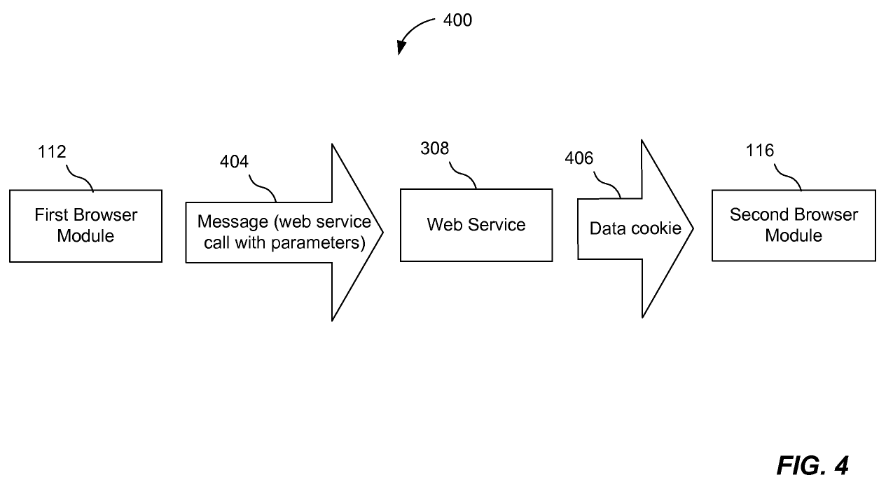

FIG. 4 depicts an exemplary diagram of process interaction for sending an inter-domain message according to one embodiment. Thus, a messaging between the first browser module 112 and a first browser module 116 is illustrated. The first browser module 112 can be configured to render the data to the first domain window 302. At the first browser module 112, a user can request a link or any other web element that references the URI by submitting a request for such URI. In other examples, no user interaction is necessary since the URI can be referenced by simply loading the first domain window 302. Such request can take the form of a message 404 which is the web service call including the parameters of the web service call. The web service call is received at the web service 308 and based on such web service call, the web service 308 can create a cookie that passes on exactly the same parameters received in the message or different parameters and/or data that are to be sent to the second browser module 116. The data submitted to the second browser module 116 can be submitted in the form of a cookie or a data cookie 406. As mentioned previously, a monitoring module 114 can be utilized to detect when the data cookie 406 has been received and therefore when the data cookie 406 can be utilized by the second browser module 116.

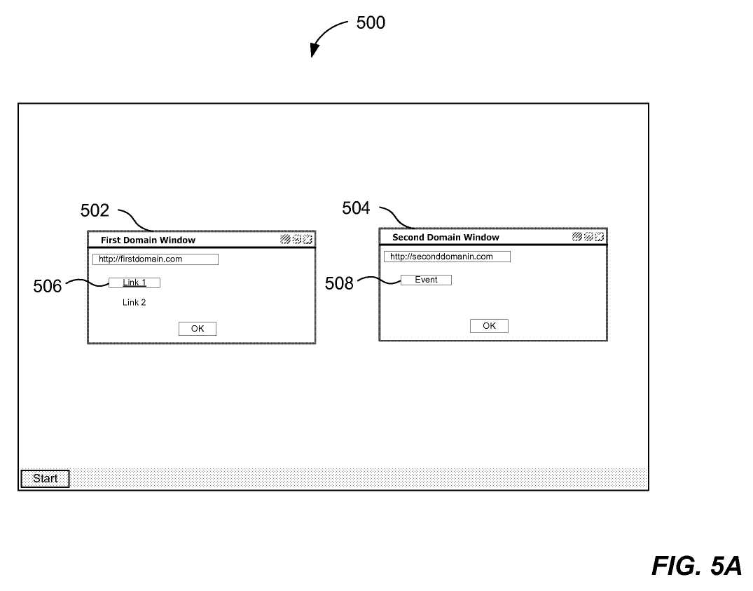

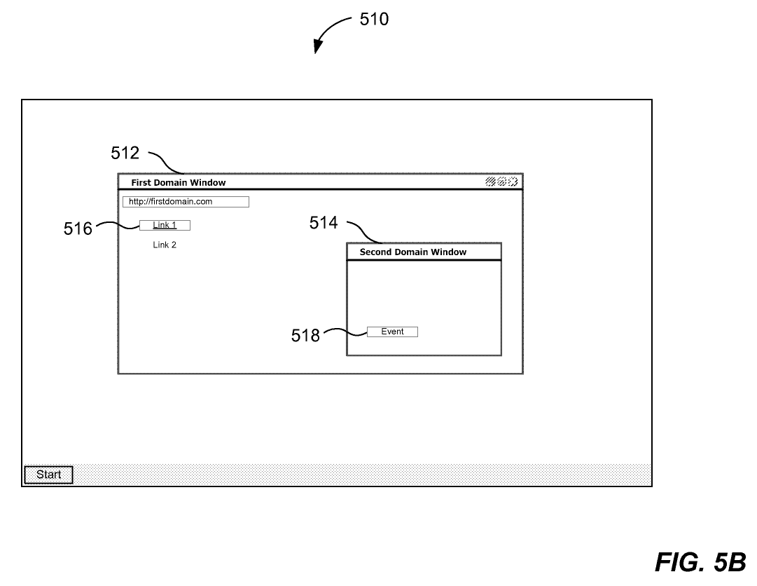

FIG. 5A depicts an exemplary user interface of a first domain window and a second domain window according to one embodiment. The first domain window 502 is a window that displays web elements received from a first domain. In one example, the web element can be a link 506 which can be accessed by selection through a pointing device or any other user interface mechanism. Likewise, a second domain window 504 can be displayed and contain one or more web elements received from a second domain. In one example, one of the elements displayed can be an event 508 which includes data received from one or more cookies sent by a web service as a result of a web service call which in turn can be generated upon a selection of link 506.

Various examples exist for applications where a first domain window 502 displaying web elements received from a first domain server 102 can call a web service of a second domain server 106 in order to cause the second domain window 504 to display web elements received from a second domain server 106.

In one example, the user can select a link 506 to view a video, and the event interface 508 can be a display window wherein the video is displayed. The video data utilized to display the video in the event interface 508 can be provided to the second domain window 504 as part of the cookie data. Upon receiving the cookie data, the second domain window 504 can display the video in the event interface 508.

In another example, the user can visit a web searching service at a first domain displayed in the first domain window, and view another domain in a second domain window. As the user enters search queries on the web searching page, the second domain window can display media related to the queries entered by the user.

FIG. 5B depicts an exemplary user interface of a first domain window and a second domain window according to another embodiment. The first domain window 514 can be a window that displays web elements received from a first domain. In one example, the web element can be a link 516 which can be accessed by selection through a pointing device or any other user interface mechanism. Likewise, a second domain window 514 can be displayed and contain one or more web elements received from a second domain. In one example, one of the elements displayed can be an event 518 which includes data received from one or more cookies sent by a web service as a result of a web service call which in turn can be generated upon a selection of link 516. According to the exemplary user interface 510, the second domain window 514 is contained and displayed as part of the first domain window 512. However, according to one embodiment, the web elements being displayed in the second domain window 514 can be provided by a domain server that is separate and distinct from the domain server that provides the web elements to the first domain window 512.

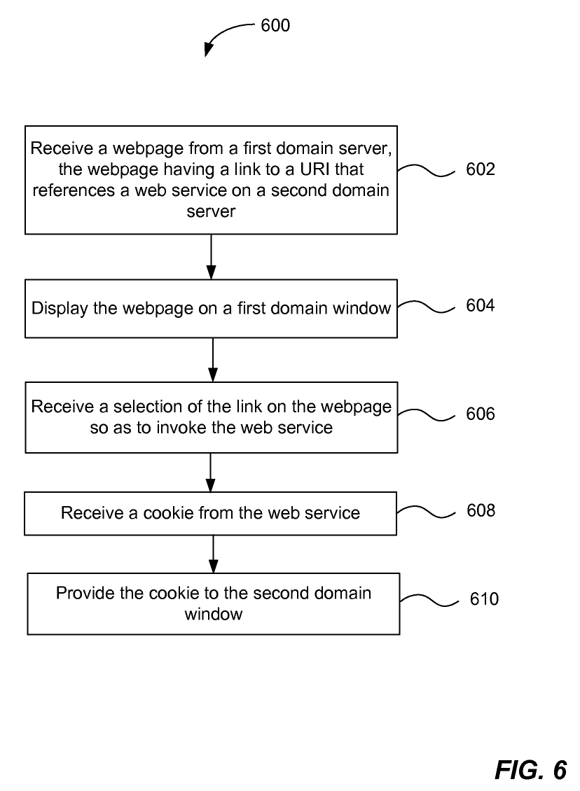

FIG. 6 depicts a flow diagram of a process for providing inter-domain messaging according to one embodiment. A web page can be received from a first domain server such that the web page can have a link included therein to a URI that references a web service on a second domain server. For example, the web page can include an image, text, or any other web element, now known or to become known, that can be linked to a URI. Process 600 continues at process block 604.

At process block 604, the web page can be displayed in a first domain window. As explained earlier, the first domain window can be a display window associated with a browsing module that receives data or that has received data from the first domain server. Process 600 continues at process block 606.

At process block 606, a selection of the link on the web page is received such that the web service is invoked. As previously mentioned, the link can have an associated URI such that when the link is selected, the URI is utilized to locate and invoke the web service referenced by the URI. Process 600 continues at process block 608.

At process block 608, a cookie is received from the web service. In one embodiment, the cookie is received at the client computer. For example, the cookie can be received by the first browser module 112. Process 600 continues at process block 610. At process block 610, the cookie is provided to the second browser module 116. Thus, for example, the cookie received by the client computer can be stored at the cookies database 110. The monitoring module 114 can detect a new cookie being received and provide the new cookie to the second browser module 116.

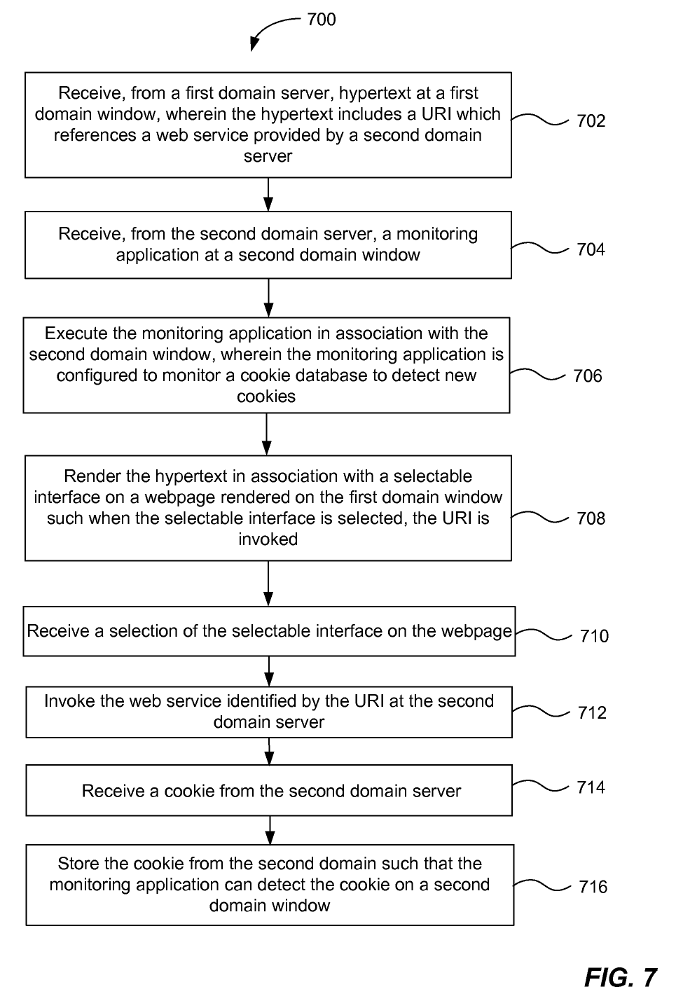

FIG. 7 depicts a flow diagram of a process for providing inter-domain messaging according to another embodiment. At process block 702, hypertext is received from the first domain server 120 at a first domain window. The hypertext can include a URI which references a web service provided by a second domain server 106. Process 700 continues at process block 704.

At process block 704, a monitoring module 116 is received from the second domain server 102 at a second domain window 304. In other words, the monitoring module 116 can be a script or any other piece of software the is downloaded from the second domain server 103 and is executed in association with the second browser module 116 which is being displayed at the second domain window 304. Process 700 continues at process block 706.

At process block 706, the monitoring module 116 is executed in association with the second domain window. The monitoring module 116 can be configured to monitor the cookies database 110 to detect any new cookies that are stored or written to the cookie database. Process 700 continues at process block 708. At process block 708, the hypertext can be rendered in association with a selectable interface on a web page rendered on the first domain window. The selectable interface can of course be an image, an icon, a string of text or any other web element that can be hyperlinked to the URI. When the selectable interface is selected by a user, the URI can then be invoked. In another embodiment, the hypertext can be provided such that when the web page rendered on the first domain window, the URI is utilized to invoke the web service that the URI references. Process 700 continues at process block 710.

At process block 710, a selection of the selectable interface is received. Process 700 continues at process block 712. At process block 712, the web service identified by the URI at the second domain server is invoked. Process 700 continues at process block 714. At process block 714, a cookie is received from the second domain server and more particularly from the web service identified by the URI. Process 700 continues at process block 716. At process block 716, the cookie received from the second domain server is stored such that the monitoring module 116 can later detect the cookie received from the web service as being newly added to the cookie database 110. As mentioned earlier, once the monitoring module 116 detects a new cookie, then the cookie data can be provided to a second browser module 116.

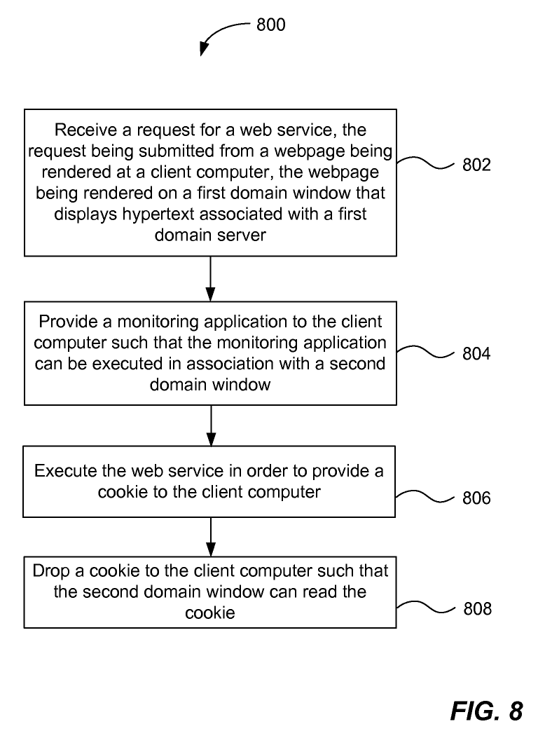

FIG. 8 depicts a flow diagram of a process for providing inter-domain messaging according to yet another embodiment. At process block 802, a request is received for a web service. A request can be received from a web page rendered at a client computer. In one embodiment, the request can comprise submitting an identifier of the web service and parameters for the web service. In another embodiment, the request comprises submitting the identifier of the web service. In one example, the request can be triggered by a user interaction at the client computer. In another example, the request can be triggered by a timeout. In yet another example, the request can be triggered by any pre-configured event. The web page on the client computer can be rendered on the first domain window that displays hypertext associated with the first domain server. Process 800 continues at process block 804.

At process block 804, a monitoring module is provided to a client computer such that the monitoring module can be executed in association with a second domain window. As such, the monitoring module can be provided by the second domain server to the client computer and monitor any cookies are received at the client computer from the web service. Process 800 continues at process block 806.

At process block 806, the web service is executed in order to provide a cookie to the client computer. Thus, because the web server resides on the second domain server, the web service can provide the cookie in order to relay information from the call received from the first domain window. As such, the cookie can include message information or any other data that the web service is configured to provide to a second domain window at the client computer. Process 800 continues at process block 808. At process block 808, the cookie is dropped to the client computer such that the second domain window can read the cookie. Of course, the second domain window can read the cookie based on an indication from the monitoring module that a new cookie has been received at the client computer.

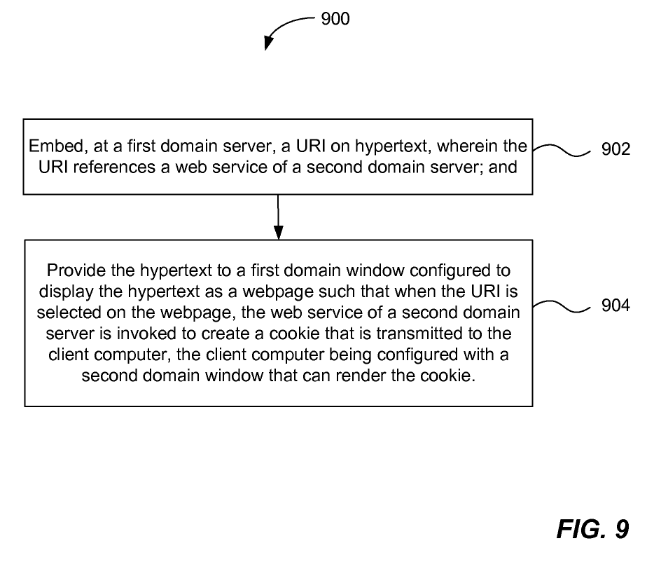

FIG. 9 depicts a flow diagram of a process for providing inter-domain messaging according to another embodiment. At process block 902, a first domain server embeds a URI on hypertext that is submitted to a client computer. The URI can reference the web service on a second domain server. Process 900 continues at process block 906. At process block 906, the hypertext can be provided to a first domain window in a client computer. The first domain window can be configured to display the hypertext as a web page such that when the URI is selected on the web page, the web service of the second domain server is invoked to create a cookie that is transmitted to the client computer. The client computer can be configured with a second domain window that can read the cookie received.

Bidirectional messaging between two browser modules can also be implemented utilizing the techniques disclosed herein. Each browser module can receive a URI that references a web service that resides on the other browser module and that drops a cookie as a result of the call of the web service.

In addition, the methods for inter-domain messaging as disclosed herein, can also apply to communication between browser modules that communicate with servers on the same domain or sub-domain.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

1. A method of relaying a digital message from a first browser module to a second browser module, comprising:
receiving a webpage from a first domain server, the webpage having a link to a URI that references a web service on a second domain server;
displaying the webpage in a first domain window;
invoking the web service by referencing the URI;
receiving a cookie from the web service; and
providing the cookie to the second browser module.

2. The method of claim 1, further comprising monitoring a cookie database to determine whether a cookie has been received from the web service.

3. The method of claim 1, wherein invoking the URI includes sending parameters to the web service.

4. The method of claim 3, wherein the parameters can include at least a portion of the digital message that the first browser module relays to the second browser module.

5. The method of claim 1, wherein the cookie includes digital data to be rendered by the second browser module.

6. The method of claim 1, wherein the first domain server is a server in a first web domain, and a second domain server is a server of a second web domain.

7. A method of relaying a digital message from a first browser module to a second browser module, comprising:
receiving, from a first domain server, hypertext at a first browser module, wherein the hypertext includes a URI which references a web service provided by a second domain server;
receiving, from the second domain server, a monitoring module at a second browser module;
executing the monitoring module in association with the second browser module, wherein the monitoring module is configured to monitor a cookie database to detect new cookies;
rendering the hypertext in association with a selectable interface on a webpage rendered on the first browser module such when the selectable interface is selected, the URI is invoked;
receiving a selection of the selectable interface on the webpage;
invoking the web service identified by the URI at the second domain server;
receiving a cookie from the second domain server; and
storing the cookie from the second domain such that the monitoring module can detect the cookie on a second window of the browser.

8. The method of claim 7, wherein invoking the web service identified by the URI includes sending parameters to the web service.

9. The method of claim 8, wherein the parameters can include at least a portion of the digital message that the first browser module relays to the second browser module.

10. The method of claim 7, wherein the cookie includes digital data to be rendered by the second browser module.

11. The method of claim 7, wherein the first domain server is a server in a first web domain, and a second domain server is a server of a second web domain.

12. A system, comprising:
a first browser module that communicates with first domain server, the first browser module being configured to receive on or more cookies from a web service of a second domain server and store the one or more cookies in a cookies database;
a second browser module that communicates with second domain server; and
a monitoring module associated with the second browser module, the monitoring module being provided by the second domain server, the monitoring module being configured to detect a new cookie in the cookie database, and to provide the new cookie to the second browser module.

13. The method of claim 12, wherein the web service is invoked by the first browser module by making a call to the web service and sending parameters to the web service.

14. The method of claim 13, wherein the parameters can include at least a portion of a digital message that the first browser module relays to the second browser module.

15. The method of claim 12, wherein the cookie includes digital data to be rendered by the second browser module.

16. The method of claim 12, wherein the first domain server is a server in a first web domain, and a second domain server is a server of a second web domain.

17. A method of receiving a digital message, comprising:
embedding, at a first domain server, a URI on hypertext, wherein the URI references a web service of a second domain server; and
providing the hypertext to a first browser module configured to display the hypertext as a webpage such that when the URI is selected on the webpage, the web service of the second domain server is invoked to create a cookie that is transmitted to the client computer, the client computer being configured with a second browser module that can read the cookie.

18. A method of receiving a digital message, comprising:
receiving a request for a web service, the request being submitted from a webpage being rendered at a client computer, the webpage being rendered by a first browser module that displays hypertext associated with a first domain server;
providing a monitoring module to the client computer such that the monitoring module can be executed in association with a second browser module;
executing the web service in order to provide a cookie to the client computer; and
dropping a cookie to the client computer such that the second browser module can read the cookie.

19. A method of sending a message from a first browser module to a second browser module, comprising:
making a call to a web service from a first browser module of a client computer by encoding the message in parameters of a call to the web service, wherein the web service is configured to parse the parameters and send a cookie back to the client computer, wherein data contained in the cookie is utilized by a second browser module.

20. A method of receiving a message, comprising:
receiving, from a web service, a cookie at a monitoring application, wherein the cookie is sent from the web service as a result of a call to the web service from a first browser module that encodes the message in parameters of the call to a web service; and
providing the data contained in the to a second browser module.
